(19) United States
(12) Patent Application Publication
(10) Pub. No.: US 2023/0085751 A1
(43) Pub. Date: Mar. 23, 2023

(54) CONTROLLING OF ELEVATOR SYSTEM

(71) Applicant: KONE Corporation, Helsinki (FI)

(72) Inventor: Antti Perko, Helsinki (FI)

(73) Assignee: KONE Corporation, Helsinki (FI)

(21) Appl. No.: 17/993,792

(22) Filed: Nov. 23, 2022

Related U.S. Application Data
(63) Continuation of application No. PCT/FI2020/050471, filed on Jun. 29, 2020.

(51) Int. Cl. B66B 1/46

(52) U.S. Cl. CPC B66B 1/468; B66B 2201/4638

(57) ABSTRACT

A solution for controlling an elevator system with an arrangement includes: at least one projector device for projecting a virtual user interface; and at least one gaze tracking device and a control unit. The control unit receives a number of images from the gaze tracking device and performs: detect a predefined input from image data; detect an intersection of the virtual user interface and a gaze point; and generate a control signal to the elevator system in accordance with a position of the gaze point intersecting the virtual user interface.

### TECHNICAL FIELD

The invention concerns in general the technical field of elevators. More particularly, the invention concerns controlling of elevator systems.

### BACKGROUND

Elevator systems interact with users through user interfaces allowing input and output of information between the parties. A typical example of such a user interface may be mentioned an elevator calling device, such as a car operating panel (COP) or a destination operating panel (DOP). An interaction with the user interface is typically performed with a finger of the user when inputting e.g. service calls to the elevator system. In other words, the user touches an area of the user interface corresponding to her/his need and the user interface generates an internal control signal in accordance with the input received from the user through the user interface. Typical way to implement the user interface is either a panel with one or more buttons or a touch screen as static implementations which may be problematic e.g. to users with special needs but also if the space in the user interface resides is crowded and the access to the panel may be difficult.

Further, there is developed other ways to provide input to the elevator system. For example, a use of eye tracking technology has been introduced e.g. in a document EP 3575257 A1 for helping persons with special needs to be able to provide input, such as service calls, to the elevator system. The eye tracking system as such is interesting also other users that those with the special needs since the technology helps avoiding physical contact between the user and the user interface, which may turn out to be necessary for health-related reasons, such as if a pandemic disease spreads in population through contacts.

Hence, there is a need to introduce solutions for mitigating the above described drawbacks as well as to take novel approaches in the area.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention.

The following summary merely presents some concepts of the invention in a simplified form as a prelude to a more detailed description of exemplifying embodiments of the invention.

An object of the invention is to present an arrangement, a method, an elevator system, and a computer program product for controlling the elevator system.

The objects of the invention are reached by an arrangement, a method, an elevator system, and a computer program product as defined by the respective independent claims.

According to a first aspect, an arrangement of an elevator system for controlling the elevator system is provided, the arrangement comprising: at least one projector device for projecting a virtual user interface; at least one gaze tracking device for capturing a number of images representing at least one eye of a person; a control unit configured to, in response to a receipt of the number of images from the gaze tracking device, perform: detect a predefined input from image data received from the gaze tracking device; detect an intersection of the virtual user interface and a gaze point, the gaze point being related to a detection of the predefined input and determined from the image data received from the gaze tracking device; generate a control signal to the elevator system in accordance with a position of the gaze point intersecting the virtual user interface.

The control unit of the arrangement may further be configured to control an operation of the at least one projector device.

Moreover, the control unit of the arrangement may be configured to perform a detection of the predefined input from image data based on a detection from at least one image among the number of images at least one of: a blink of the at least one eye of the person; a position of the gaze point remains stationary with a predefined margin a period of time exceeding a predefined threshold time.

For example, the control unit of the arrangement may be configured to generate the control signal to the elevator system in accordance with the position of the gaze point intersecting the virtual user interface in response to a detection that the gaze point intersects a predefined area of the virtual user interface.

The control unit of the arrangement may also be configured to determine a relation of the gaze point to the detection of the predefined input by one of: the gaze point corresponds to a gaze point determined from at least one same image as from which image the predefined input is detected; the gaze point corresponds to a gaze point determined from at least one previous image to the image from which the predefined input is detected.

The projector device of the arrangement may be arranged to generate the virtual user interface by projecting it to at least one of: a physical surface, air.

For example, the projector device may be arranged to project the virtual user interface to the physical surface with a light beam.

Alternatively or in addition, the projector device may be arranged to project the virtual user interface to the air by applying a photophoretic optical trapping technique.

Still further, the projector device may be arranged to project the virtual user interface to the air by controlling a foam bead with ultrasound waves to meet a light generated by the projector device.

In still further example, the projector device may be arranged to project the virtual user interface to the air by utilizing a fog screen as a projecting surface in the air.

According to a second aspect, a method for controlling an elevator system is provided, the method, performed by an apparatus, comprising: receiving a number of images representing at least one eye of a person received from a gaze tracking device; detecting a predefined input from image data received from the gaze tracking device; detecting an intersection of a virtual user interface and a gaze point, the gaze point being related to a detection of the predefined input and determined from the image data received from the gaze tracking device; and generating a control signal to the elevator system in accordance with a position of the gaze point intersecting the virtual user interface.

Further, the method may comprise: controlling an operation of the at least one projector device.

A detection of the predefined input from image data may e.g. be performed based on a detection from at least one image among the number of images at least one of: a blink of the at least one eye of the person; a position of the gaze point remains stationary with a predefined margin a period of time exceeding a predefined threshold time.

For example, the control signal to the elevator system may be generated in accordance with the position of the gaze point intersecting the virtual user interface in response to a detection that the gaze point intersects a predefined area of the virtual user interface.

A relation of the gaze point to the detection of the predefined input may be determined by one of: the gaze point corresponds to a gaze point determined from at least one same image as from which image the predefined input is detected; the gaze point corresponds to a gaze point determined from at least one previous image to the image from which the predefined input is detected.

The virtual user interface may be generated by controlling the at least one projector device to project the virtual user interface to at least one of: a physical surface, air.

According to a third aspect, an elevator system is provided, the elevator system comprising an arrangement according to the first aspect as defined above.

According to a fourth aspect, a computer program is provided, the computer program comprising computer readable program code configured to cause performing of the method according to the second aspect as defined above when said program code is run on one or more computing apparatuses.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically a method according to an example.

FIG. 3 illustrates schematically some aspects in relation to an example.

FIG. 4 illustrates schematically an apparatus according to an example.

### DESCRIPTION OF THE EXEMPLIFYING EMBODIMENTS

The specific examples of the invention provided in the description given below should not be construed as limiting the scope and/or the applicability of the appended claims. Lists and groups of examples provided in the description given below are not exhaustive unless otherwise explicitly stated.

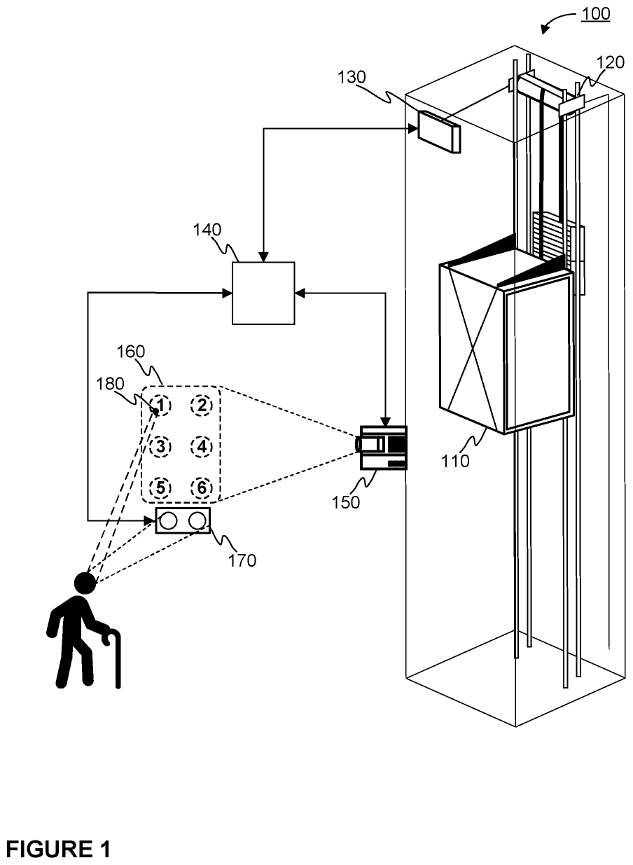

FIG. 1 illustrates schematically an example of an elevator system 100 comprising at least one elevator car 110 which may travel in a shaft under control of a drive 120. The drive 120 may be controlled by an elevator controller 130. The elevator controller 130 may be a central controlling entity of the elevator system 100 which may generate control signals to the drive and other elevator entities e.g. in accordance with service calls received e.g. persons visiting a building into which the elevator system 100 is implemented to. The elevator system 100 may comprise other entities than the ones mentioned above. For example, the elevator system 100 comprises a plurality of doors, such as elevator car doors and hall doors, as well as signaling devices, such as gongs and similar, for providing information to persons intending to interact with the elevator system 100, such as use it.

Further, FIG. 1 illustrates schematically an arrangement for generating service calls to the elevator system 100. The arrangement may comprise a control unit 140, a projector device 150 and a gaze tracking device 170. The control unit 140 may be arranged to control an operation of the projector device 150 and the gaze tracking device 170 as is described, as a non-limiting example, in the forthcoming description. The control unit 140 of the arrangement may be dedicated to the arrangement or it may also be arranged to perform other control operations. In some examples, the control operations of the control unit 140 of the arrangement may be implemented in the elevator controller 130. In case the control unit 140 is a separate entity to the elevator controller 130 it may be arranged that the elevator controller 130 is a master device with respect to the control unit 140, which may operate as a slave device under a control of the elevator controller 130.

The projector device 150 may be a device configured to generate an image of a user interface 160 of the elevator system 100 in accordance with a control by the control unit 140. The image of the user interface 160 is called as a virtual user interface 160 herein. The virtual user interface 160 may refer to any user interface of the elevator system 100 through which the person may interact with the elevator system as is described herein. The virtual user interface 160 may e.g. represent a car operating panel (COP) or a destination operating panel (DOP) or any other. The virtual user interface 160 may be projected to a medium suitable for the projection by the projector device 150. In accordance with an example, the projector device 150 may be such that it may generate the virtual user interface 160 by projecting a predefined image accessible by a control unit 140, or the projector device 150 itself, on a predefined surface, such as on a wall. The predefined image may e.g. be stored in data storage, such as in an internal memory of the control unit 140 or the projector device 150 wherefrom the image may be retrieved e.g. in response to a control signal generated by the control unit 140. According to another example, the virtual user interface 160 may be projected to air as a 2-dimensional surface projection or even as a 3-dimensional volume projection. The projection of the virtual user interface 160 to air may be implemented by applying so-called photophoretic optical trapping which may be implemented by the projector device 150 e.g. under control of the control unit 140. In another example, the projecting to the air may be achieved by establishing so-called fog screen in a desired location in the space and project the virtual user interface 160 on the fog screen. In a still further example, the image in a 3-dimensional volume may be generated by using ultrasound waves to control a movement of a foam bead, such as a polystyrene bead, between a plurality of speakers, and by projecting light e.g. with LEDs in the volume an image may be generated when the light ray hits the bead. In some examples the virtual user interface 160 shall be understood as a hologram of the user interface. The listed techniques to generate the virtual user interface 160 are non-limiting example and any applicable solution may be applied in this context.

In general, the image may be generated by transmitting electromagnetic radiation with an applicable wavelength, such as with a wavelength of a visible light or a laser light, to a selected medium. Moreover, the image i.e. the virtual user interface 160 has a known size and shape so as visualize one or more areas in the image, such as areas representing destination floors for a selection by the person in a manner as is to be described. Still further, the generated virtual user interface has a known location in a space defined by a coordination system by means of which the areas of the virtual user interface 160 may be defined as areas, or even as volumes, in the coordinate system (cf. 2-dimensional or 3-dimensional). The information relating to the location of the virtual user interface as well as the size and the shape of it, may be managed by the control unit 140.

Depending on the implementation of the arrangement in the elevator system 100 the projector device 150 may be arranged to generate the image to one or more predefined locations in the space. In case a plurality of images are generated it may be performed by a single projector device 150 if the projector device 150 is suitable for such an operation or with a plurality of projector devices 150 controllable by the control unit 140. Alternatively or in addition, the image may be generated to a one predefined locations among a plurality of possible locations with a respective projector device 150, such as the one belonging to the arrangement whose beam may be directed to the predefined locations or by controlling one of the projector devices 150 to perform the operation. The location of the virtual user interface 160 may be selected based on a receipt of predefined input data, such as data from one or more sensors. For example, the building may be equipped with one or more sensors, e.g. along a path towards the elevator, and based on a detection of the person on a basis of sensor data, the control unit 140 may be configured to generate a control signal to the respective projector device(s) 150 to generate the virtual user interface 160 to one of the locations and maintain the information for further processing.

The arrangement may further comprise at least one gaze tracking device 170 arranged to capture data for determining the person's gaze point (black dot referred with 180 in FIG. 1). The determination of the gaze point may be performed by tracking of at least one eye of the person with the gaze tracking device 170 and based on that perform a determination of the gaze point. In accordance with an example the gaze tracking device 170 may perform so that it is arranged to emit a light beam at predefined wavelength, such as at near infrared wavelength. At least portion of the light beam hits at least one eye of the person and a part of that light is reflected back towards the gaze tracking device 170. The gaze tracking device 170 comprises a number of sensors for capturing the reflection from the at least one eye. The number of sensors may correspond to an image capturing device which may capture images at high frame rate so as to enable tracking the movements of the eyes in the described manner. The captured image data may be analysed with an applicable image processing algorithm suitable for detecting useful details from the image portions representing person's eyes and reflections and by interpreting the image stream it is possible to determine the position of the person's eyes and their gaze point at the location under monitoring. Thus, the analysis comprises both filtering of the data as well as applying triangulation to determine the gaze point 180.

In accordance with the present application area the arrangement may be configured to operate so that the control unit 140 is arranged to determine a position of the gaze point 180 with respect to the virtual user interface 160, and any areas of that, generated by the projector device 150. This is possible due to that the control unit 140 is aware of the location of the virtual user interface 160 in the space and by receiving the data representing the gaze point 180 it is possible to estimate a position of the virtual user interface 160 the person stares at. The estimation of the position of the gaze point 180 with respect to the virtual user interface 160 may be performed by estimating an intersection point of the gaze point of the at least one eye derived from data obtained with the gaze tracking device 170 and the virtual user interface 160 generated by projecting the image representing the user interface to the known location. In other words, the determined gaze point 180 shall comprise a number of common position points with the virtual user interface 160 when these are determined in the common coordinate system. In some examples, the gaze point 180 may correspond to an intersection of a line of sight determined from the data obtained from the gaze tracking device 170 with a surface representing the virtual user interface 160. For sake of completeness it is worthwhile to mention that if the virtual user interface 160 is implemented as a 3-dimensional object, the gaze point 180 in a volume comprising the 3-dimensional object representing the virtual user interface 160 is to be determined in order to enable a detection of the selection through the virtual user interface 160.

Now, at some point of time the person is willing to provide in indication of his/her selection to the elevator system 100. This may be performed by arranging the control unit 140 to detect, from data received from the gaze tracking device 170, a predefined input from the person to indicate the selection. For example, the input may be an eye blink of at least one eye detectable from the image stream received with the gaze tracking device 170. In accordance with some other example, the input may be given by staring at the same position, with an applicable margin, a time exceeding a threshold time set for the selection. In other words, if the person keeps her/his gaze at the same position on the virtual user interface 160 over a predefined time, it may be interpreted to correspond to a selection. In other words, if the virtual user interface 160 represents destination floors and it is detected that the person stares at a certain area representing a certain floor, it may concluded by the control unit 140 that the person is willing to travel to the respective floor and the control unit 140 may be arranged to generate a control signal to the elevator controller 130 to indicate the destination floor in the elevator system 100. In this manner, the elevator controller 130 may perform an allocation of the elevator car 110 to serve the service call given in the form of the destination call through the arrangement.

It is worthwhile to mention that a number of the gaze tracking devices 170 may be selected in accordance with the implementation. For example, if the arrangement is implemented so that there a plurality of locations into which the virtual user interface 160 may be generated, there may be a need to arrange a plurality of gaze tracking devices 170 in a plurality of positions so that it is possible to monitor person's eyes with respect to the plurality of virtual user interfaces 160 at the different possible locations.

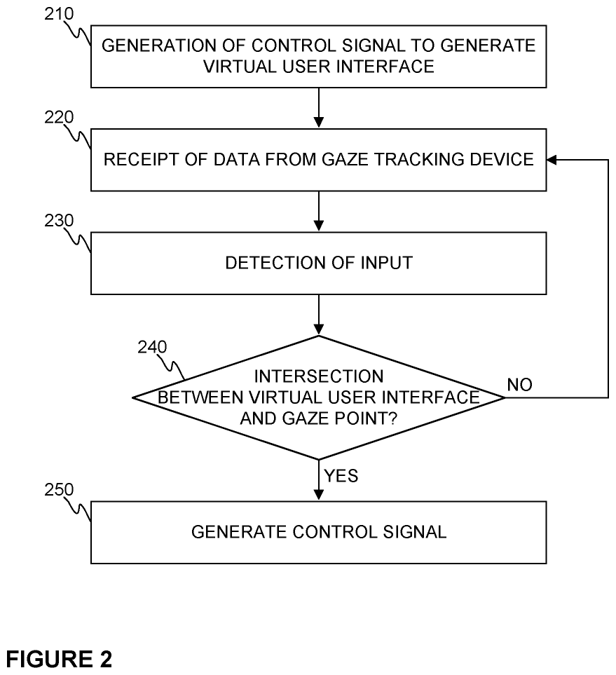

Next, some aspects of an example are described by referring to FIG. 2 illustrating schematically a method for controlling an elevator system 100. The method as schematically illustrated in FIG. 2 may be implemented in an elevator system 100 of FIG. 1 by utilizing the arrangement as described for performing at least a part of the method. For the purpose of understanding of the method schematically illustrated in FIG. 2 it is hereby assumed that an entity performing the method is a control unit 140 of FIG. 2. The method may be initiated by a generation 210 of a control signal to a projector device 150 to generate a virtual user interface 160. The control signal may e.g. be generated in response to a detection that a person resides at a predefined location, such as in a location through which an elevator may be reached. The detection may e.g. be performed by receiving sensor data based on which it may be determined that the person resides at the predefined location. The generation of the control signal to generate the virtual user interface 160 may also cause an initiation of a tracking of gaze of the person. This may also be arranged by generating a trigger signal from the control unit 140 to the gaze tracking device 170. The gaze tracking device 170 of the arrangement may generate data, such as image data at a high frame rate, which may be received 220 by the control unit 140. The initiation of the projector device 150 and the gaze tracking device 170 may be arranged to occur concurrently or subsequently to each other, preferably so that in subsequent implementation the projector device 150 is initiated prior to the gaze tracking device 170.

The gaze tracking device 170 may perform a monitoring of a movement of the gaze and generate image stream to the control unit 140 accordingly. At some point the person may give an input to the arrangement with at least one predefined method, such as blinking of at least one eye or staring at the same point over a threshold time, and the input may be detected 230 by the control unit 140 from one or more images. In response to the receipt of the input the control unit 140 may be arranged to determine the gaze point 180 at the time of input, or just before the input, from the received images. For example, if the input giving method is based on a detection of the blink of the at least one eye the control unit 140 may be arranged to define the gaze point 180 from at least one previous image frame to the image frame from which the blink of the at least one eye is detected. According to another example, if the input mechanism is based on a detection that the gaze point 180 remains at a certain position, with applicable margins, over the threshold time, the position of the gaze point 180 may be determined from the same image frame as is the last one for the decision-making of the input, or from any previous image frame in which the position of the gaze point 180 has remained the same.

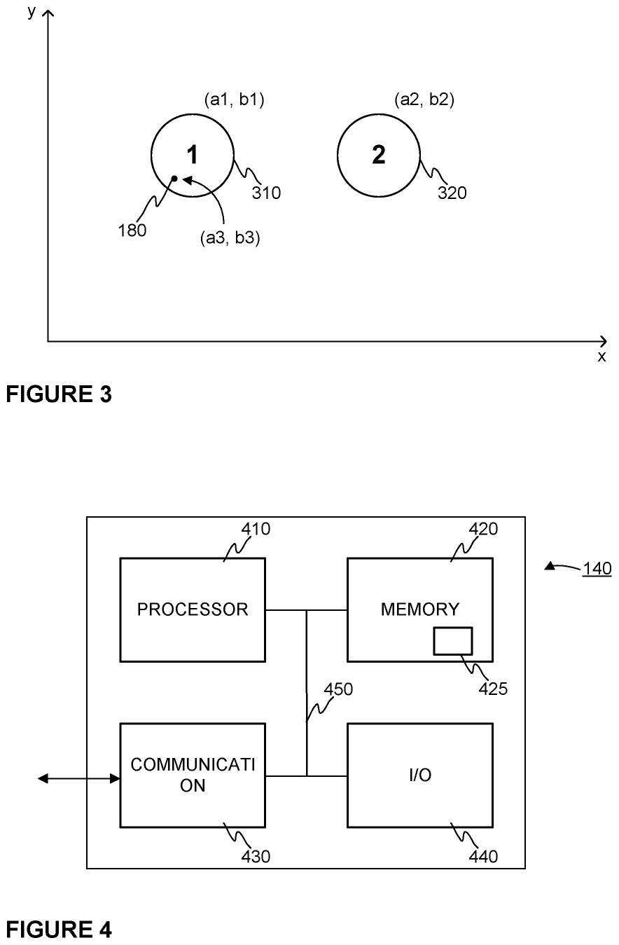

In response to the receipt of the input the control unit 140 may be configured to detect 240 if the gaze point 180 indicated with the input is within an area, or in a volume, of the virtual user interface 160 and at which position the gaze point intersects with the virtual user interface 160 and/or any sub-area thereof if any. In other words, the aim is to determine if the gaze point resides in such a point within the virtual user interface 160 which causes a request in the elevator system 100. An example of this is schematically illustrated in FIG. 3 wherein the virtual user interface 160 projected to the person comprises two virtual buttons 310, 320 in a form of circles. Through the virtual buttons 310, 320 it is possible to deliver service calls to the elevator system 100 through the gaze tracking. In order to detect if the gaze point 180 resides within the area of any of the virtual buttons 310, 320 when the input is given by the person the virtual buttons may be mathematically defined in a coordinate system. For example, the circular buttons 310, 320 may be defined in the coordinate system as follows:

(x−a1)²+(y−b1)²=r², and Circle 310:

(x−a2)²+(y−b2)²=r² Circle 320:

wherein (a1, b1) and (a2, b2) represent the coordinates of the centres of the respective circles, and r represents the radius of the circles which in this nonlimiting example is the same for the both circles. In other words, the above given equations defined the areas of the respective circles in the coordinate system.

Now, the position of the gaze point 180 in relation to the input as described is determined in the same coordinate system. For example, the gaze point 180 in the present example in relation to the input under consideration may be (a3, b3). Hence, the control unit 140 may be arranged to detect if the gaze point 180 resides within the area of any of the virtual buttons 310, 320 by determining if any one of the following equations is true in a position (a3, b3) in the coordinate system:

(x−a1)²+(y−b1)²=r², or

(x−a2)²+(y−b2)²=r².

In the fictitious non-limiting example of FIG. 3 the determination returns that the equation of the first virtual circle 310 is true with the position (a3, b3) in the coordinate system and, hence, the control unit 140 may conclude that the person is willing to execute a command corresponding the item 310 in the virtual user interface 160. For example, the control unit 140 may be arranged to interpret the detection so that the person is willing to travel to the floor 1, i.e. the person has given a destination call, and in response to the interpretation, the control unit 140 may generate a control signal 250 in accordance with the interpretation of the selection. Alternative to the above given description of the selection it may turn out that the gaze point does not intersect with any of the predefined selectable areas of the virtual user interface 160, the control unit 140 may be configured to continue monitoring of the gaze point by continuing a receipt 220 of data from the gaze tracking device 170 and to perform a new detection 230 representing the input in order to perform an interpretation if the gaze point 180 resides within the virtual user interface 160.

In the foregoing description the step 240 of FIG. 2 is mainly described in an implementation based on 2-dimensional environment, such as the one schematically illustrated in FIG. 3. However, the similar interpretation may be performed if the virtual user interface 160 is generated in a 3-dimensional manner. In such an implementation the control unit 140 may be arranged to perform an estimation if the gaze point 180 resides in a predefined volume, or on its surface, and to perform in accordance with an output of such an estimation in the same manner as described. This may be done e.g. by obtaining stereo images of the eyes of the user and analysing the image data, or by applying any other suitable technique for determining the gaze point in the volume.

For example, the control unit 140 may refer to a computing device, such as a server device, a laptop computer, or a PC, as schematically illustrated in FIG. 4. FIG. 4 illustrates schematically as a block diagram a non-limiting example of the control unit 140 applicable to perform the method in cooperation with other entities. The block diagram of FIG. 4 depicts some components of a device that may be employed to implement an operation of the control unit 140. The apparatus comprises a processor 410 and a memory 420. The memory 420 may store data and computer program code 425. The apparatus may further comprise communication means 430 for wired and/or wireless communication with other entities, such as with at least one projector device 150, at least one gaze tracking device 170, and an elevator controller 130. Furthermore, I/O (input/output) components 440 may be arranged, together with the processor 410 and a portion of the computer program code 425, to provide a user interface for receiving input from a user, such as from a technician of the elevator system 100, and/or providing output to the user of the system when necessary. In particular, the user I/O components may include user input means, such as one or more keys or buttons, a keyboard, a touchscreen, or a touchpad, etc. The user I/O components may include output means, such as a display or a touchscreen. The components of the apparatus may be communicatively coupled to each other via a bus 450 that enables transfer of data and control information between the components.

The memory 420 and a portion of the computer program code 425 stored therein may be further arranged, with the processor 410, to cause the apparatus, i.e. the device to perform a method as described in the foregoing description. The processor 410 may be configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some or all of which may be integrated/removable and/or may provide permanent/semi-permanent/dynamic/cached storage.

The computer program code 425 may comprise computer-executable instructions that implement functions that correspond to steps of the method when loaded into the processor 410. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus to perform the method be described. Hence, the apparatus may comprise at least one processor 410 and at least one memory 420 including the computer program code 425 for one or more programs, the at least one memory 420 and the computer program code 425 configured to, with the at least one processor 410, cause the apparatus to perform the method as described.

The computer program code 425 may be provided e.g. a computer program product comprising at least one computer-readable non-transitory medium having the computer program code 425 stored thereon, which computer program code 425, when executed by the processor 410 causes the apparatus to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 425 may comprise a proprietary application, such as computer program code for executing the control of the elevator system in the manner as described.

Any of the programmed functions mentioned may also be performed in firm-ware or hardware adapted to or programmed to perform the necessary tasks.

Moreover, as mentioned a functionality of the apparatus implementing the control unit 140 may be shared between a plurality of devices as a distributed computing environment. For example, the distributed computing environment may comprise a plurality of devices as schematically illustrated in FIG. 4 arranged to implement the method in cooperation with each other in a predetermined manner. For example, each device may be arranged to perform one or more method steps and in response to a finalization of its dedicated step it may hand a continuation of the process to the next device. The devices may e.g. be a control unit 140 and the elevator controller 130, for example.

Some aspects relate to an elevator system 100 comprising the arrangement as described in the foregoing description and wherein the method as described may be performed in order to control the elevator system accordingly.

An advantage of the examples as described is that they provide a sophisticated solution for interacting with the elevator system 100. The solution provides a way to establish the user interface to an optimal position with respect to people flow in premises as well as enable touchless interaction with the elevator system which may e.g. prevent a spread of diseases.

The specific examples of the invention provided in the description given above should not be construed as limiting the applicability and/or the interpretation of the appended claims. Lists and groups of examples provided in the description given above are not exhaustive unless otherwise explicitly stated.

1. An arrangement of an elevator system for controlling the elevator system, the arrangement comprising:
at least one projector device for projecting a virtual user interface;
at least one gaze tracking device for capturing a number of images representing at least one eye of a person; and
a control unit configured to, in response to a receipt of the number of images from the gaze tracking device, perform:
detect a predefined input from image data received from the gaze tracking device;
detect an intersection of the virtual user interface and a gaze point, the gaze point being related to a detection of the predefined input and determined from the image data received from the gaze tracking device; and
generate a control signal to the elevator system in accordance with a position of the gaze point intersecting the virtual user interface.

2. The arrangement of the elevator system of claim 1, wherein the control unit is further configured to control an operation of the at least one projector device.

3. The arrangement of the elevator system of claim 1, wherein the control unit is configured to perform a detection of the predefined input from the image data based on a detection from at least one image among the number of images at least one of: a blink of the at least one eye of the person; and a position of the gaze point remains stationary with a predefined margin a period of time exceeding a predefined threshold time.

4. The arrangement of the elevator system of claim 1, wherein the control unit is configured to generate the control signal to the elevator system in accordance with the position of the gaze point intersecting the virtual user interface in response to a detection that the gaze point intersects a predefined area of the virtual user interface.

5. The arrangement of claim 1, wherein the control unit is configured to determine a relation of the gaze point to the detection of the predefined input by one of: the gaze point corresponds to a gaze point determined from at least one same image as from which image the predefined input is detected; and the gaze point corresponds to a gaze point determined from at least one previous image to the image from which the predefined input is detected.

6. The arrangement of the elevator system of claim 1, wherein the projector device is arranged to generate the virtual user interface by projecting the virtual user interface to at least one of: a physical surface; and air.

7. The arrangement of the elevator system of claim 6, wherein the projector device is arranged to project the virtual user interface to the physical surface with a light beam.

8. The arrangement of the elevator system of claim 6, wherein the projector device is arranged to project the virtual user interface to the air by applying a photophoretic optical trapping technique.

9. The arrangement of the elevator system of claim 6, wherein the projector device is arranged to project the virtual user interface to the air by controlling a foam bead with ultrasound waves to meet a light generated by the projector device.

10. The arrangement of the elevator system of claim 6, wherein the projector device is arranged to project the virtual user interface to the air by utilizing a fog screen as a projecting surface in the air.

11. A method for controlling an elevator system, the method, performed by an apparatus, comprising:
receiving a number of images representing at least one eye of a person received from a gaze tracking device;
detecting a predefined input from image data received from the gaze tracking device;
detecting an intersection of a virtual user interface and a gaze point, the gaze point being related to a detection of the predefined input and determined from the image data received from the gaze tracking device; and
generating a control signal to the elevator system in accordance with a position of the gaze point intersecting the virtual user interface.

12. The method of claim 11, wherein the method further comprises:
controlling an operation of the at least one projector device.

13. The method of claim 11, wherein a detection of the predefined input from image data is performed based on a detection from at least one image among the number of images at least one of: a blink of the at least one eye of the person; and a position of the gaze point remains stationary with a predefined margin a period of time exceeding a predefined threshold time.

14. The method of any claim 11, wherein the control signal to the elevator system is generated in accordance with the position of the gaze point intersecting the virtual user interface in response to a detection that the gaze point intersects a predefined area of the virtual user interface.

15. The method of claim 11, wherein a relation of the gaze point to the detection of the predefined input is determined by one of: the gaze point corresponds to a gaze point determined from at least one same image as from which image the predefined input is detected; and the gaze point corresponds to a gaze point determined from at least one previous image to the image from which the predefined input is detected.

16. The method of claim 11, wherein the virtual user interface is generated by controlling the at least one projector device to project the virtual user interface to at least one of: a physical surface; and air.

17. An elevator system comprising the arrangement according to claim 1.

18. A computer program embodied on a non-transitory computer readable medium and comprising computer readable program code configured to cause performing of the method according to claim 11 when said program code is run on one or more computing apparatuses.

19. The arrangement of the elevator system of claim 2, wherein the control unit is configured to perform a detection of the predefined input from image data based on a detection from at least one image among the number of images at least one of: a blink of the at least one eye of the person; and a position of the gaze point remains stationary with a predefined margin a period of time exceeding a predefined threshold time.

20. The arrangement of the elevator system of claim 2, wherein the control unit is configured to generate the control signal to the elevator system in accordance with the position of the gaze point intersecting the virtual user interface in response to a detection that the gaze point intersects a predefined area of the virtual user interface.
